(19) United States
(12) Patent Application Publication
(10) Pub. No.: US 2009/0089810 A1
(43) Pub. Date: Apr. 2, 2009

(54) System and a Method for Generating a Closed Homogeneous Non-Distributed Application from an Open Heterogeneous Distributed Application

(75) Inventors: Oksana I. Tkachuk, Palo Alto, CA (US); Sreeranga P. Rajan, Sunnyvale, CA (US)

Correspondence Address: BAKER BOTTS L.L.P., 2001 ROSS AVENUE, SUITE 600, DALLAS, TX, 75201-2980, US

(73) Assignee: Fujitsu Limited, Kawasaki-shi (JP)

(21) Appl. No.: 11/865,435

(22) Filed: Oct. 1, 2007

(51) Int. Cl. G06F 9/44

(52) U.S. Cl. 719/320

(57) ABSTRACT

In accordance with a particular embodiment of the present invention, a method is offered that includes executing processing on an open heterogeneous distributed application, whereby the application is partially written in Java code. The method further includes generating a closed homogeneous non-distributed Java application based on the open heterogeneous distributed application. In more specific embodiments, in generating the closed homogeneous non-distributed Java application, drivers and stubs are generated. Once drivers and stubs are generated, they are combined with an original code base to produce the closed homogeneous non-distributed Java application. Driver generation produces a Java implementation of a user component, along with setting up an event-handling mechanism of the application, which is done at deployment, whereby the stub generation replaces a database and various libraries (e.g., J2EE) with Java implementations that preserve important behaviors.

### TECHNICAL FIELD OF THE INVENTION

This invention relates generally to the field of software verification and, more specifically, to a system and a method for generating a closed homogeneous non-distributed application from open heterogeneous distributed applications.

### BACKGROUND OF THE INVENTION

Formal verification techniques usually work for closed homogeneous non-distributed applications. For example, taking Java as an example language and model checking as an example verification method, Java model-checking techniques work for programs that are self-executable, written in pure Java and ready to run on a single Java Virtual Machine (JVM). However, there are many applications that are open, heterogeneous, and distributed in nature, e.g., web applications, which are: 1) driven by an end user; 2) comprised of artifacts written in many languages (e.g., Java, JavaScript, HTML, and XML); 3) deployed in a distributed environment, with client, server, and database potentially residing on different machines. To apply Java model-checking techniques, all non-Java components [including a user] need to be represented as pure Java implementations. In addition, the distributed nature of applications needs to be dealt with so that the resulting Java program is non-distributed but preserves all of the relevant behaviors of the original application. As with all such processing operations, of critical importance are issues relating to speed, accuracy, and automation.

### SUMMARY OF THE INVENTION

The present invention provides a method and a system for generating a closed homogeneous non-distributed application (from open heterogeneous distributed applications) that substantially eliminates or reduces at least some of the disadvantages and problems associated with previous methods and systems.

In accordance with a particular embodiment of the present invention, a method is offered that includes executing processing on an open heterogeneous distributed application, whereby the application is partially written in Java code (although the methodology is equally applicable to other programming languages). The method further includes generating a closed homogeneous non-distributed Java application based on the open heterogeneous distributed application. In more specific embodiments, in generating the closed homogeneous non-distributed Java application, drivers and stubs are generated. Once drivers and stubs are generated, they are combined with an original application-specific code base (generally called a module under analysis) to produce the closed homogeneous non-distributed Java application. In the domain of web applications, driver generation produces a Java implementation of a user component, along with setting up an event-handling mechanism of an application, which is done at deployment, whereby the stub generation replaces various back-end components (e.g., database and J2EE components) with Java implementations that preserve important behaviors. The end result, the closed homogeneous non-distributed Java application, is purely Java.

Technical advantages of particular embodiments of the present invention include a methodology that is packaged as a stand-alone tool. The method for environment generation for open, heterogeneous, distributed applications is used as a stand-alone tool, which is capable of being used in combination with model-checking, static analysis, or testing. In addition, the tool can be configured and extended based on specific domains. Thus, such tools can be applied to a variety of applications. Also, the method produces drivers and stubs, which can be thought of as test harnesses that can be used by several technologies such as model-checking, static analysis, and testing.

Other technical advantages will be readily apparent to one skilled in the art from the following figures, descriptions, and claims. Moreover, while specific advantages have been enumerated above, various embodiments may include all, some or none of the enumerated advantages.

### BRIEF DESCRIPTION OF THE DRAWINGS

For a more complete understanding of particular embodiments of the invention and their advantages, reference is now made to the following descriptions, taken in conjunction with the accompanying drawings, in which:

FIG. 1 is a simplified diagram illustrating an example web applications domain related to one embodiment of the present invention;

FIG. 2 is a simplified block diagram illustrating example techniques for environment generation;

FIG. 3 is a simplified block diagram illustrating an example environment generation for web applications in accordance with one embodiment of the present invention; and

FIGS. 4 and 5 are simplified block diagrams illustrating example architectures for generating a closed homogeneous non-distributed application from open heterogeneous distributed web applications.

### DETAILED DESCRIPTION OF THE INVENTION

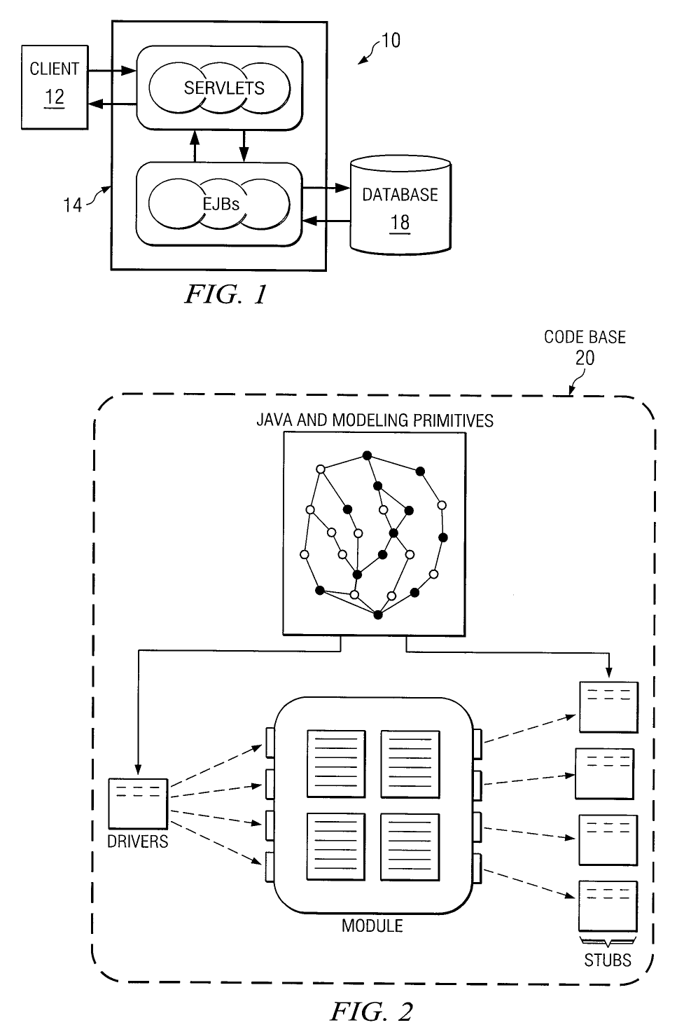

FIG. 1 is a simplified diagram illustrating an example web applications domain 10 related to one embodiment of the present invention. FIG. 1 includes a client 12, a database 18, and a J2EE server 14, which includes servlets and enterprise Java beans (EJBs).

In accordance with the teachings of example embodiments of the present invention, a system for effectively providing environment generation for web applications is offered. Such a methodology can transform open heterogeneous distributed web applications, partially written in Java, into closed homogeneous non-distributed Java programs, ready to be analyzed by formal verification techniques (e.g., such as Java model-checking).

The technique provides for the generation of drivers and stubs. Driver generation produces a Java implementation of a user component, along with setting up the event-handling mechanism of web applications, done at deployment. Stub generation can replace actual components, such as database and J2EE components, with Java implementations that preserve important behaviors, but that run in a non-distributed program. Once drivers and stubs are generated, they are combined with the original application-specific code base (excluding original libraries) to produce a closed homogeneous non-distributed Java program.

There is a multitude of advantages to using such an approach. For example, the tendered methodology can be packaged as a stand-alone tool. In addition, the tools can be configured and extended based on specific domains. Thus, the tools can be applied to a variety of applications. Also, the method produces drivers and stubs, which can be thought of as test harnesses that can be used by several technologies such as model-checking, static analysis, and testing.

Turning back now to FIG. 1, the term ‘open’ refers to a situation in which a user component drives the application through a web browser, applet, or a Graphical User Interface (GUI). The term ‘heterogeneous’ refers to the fact that, in addition to Java, many other languages are used, e.g., HTML, JavaScript, PHP, Perl, etc. In the context of the present invention, ‘complex’ connotes a multiple-layered architecture, typically distributed in nature, where a major part of the application is generated at deployment, according to deployment descriptor files.

Note that existing model-checking techniques, which are applicable only to closed homogeneous and non-distributed systems, require additional modeling: called environment generation. The present invention relates to generating test harness/test suite/test cases for detecting defects in open heterogeneous distributed applications. This is typically the first step of any testing/verification technique. The architecture of verification tools is usually published in white papers of products from companies and, therefore, it is relatively easy to identify similarities with these items and environment generation tools proposed by the present invention.

Thus, the system offered herein provides a method to generate a closed homogeneous non-distributed Java application from open heterogeneous distributed applications, partially written in Java. The environment generation for such applications can be packaged as a stand-alone tool, which can be used in combination with model-checking, static analysis, and testing. Such environment generation for model-checking Java implementations of open heterogeneous distributed applications is not currently accounted for in existing systems.

FIG. 2 is a simplified block diagram illustrating example techniques for environment generation in an example system 20. Given a module under analysis as a collection of Java classes (e.g., an application-specific code base, excluding reusable libraries), environment generation produces module's drivers and stubs. Drivers are Java classes that hold a thread of control and usually make calls to the module. The remaining environment classes are called stubs. In the domain of web applications, the drivers simulate end users and stubs model back-end components such database and J2EE libraries.

In regards to modeling primitives, special methods that model non-determinism in the environment are provided. Existing environment generation techniques are applicable to homogeneous systems only and rely on user specifications, generic static and dynamic analyses that work for pure Java implementations only.

Thus, new techniques are needed to process heterogeneous systems. Specifically, in the domain of web applications, new techniques are needed to process deployment descriptor files, which contain information about: 1) event-handling mechanisms, including event-handling mappings; 2) containment and lookup mechanisms; 3) nature of EJBs (entity and session beans, their lifecycle); and 4) authentication mechanisms used in a specific application.

All of these complex features are generated dynamically at deployment according to descriptor files and domain semantics. The resulting deployed application runs in a distributed environment, not currently handled by model-checking engines.

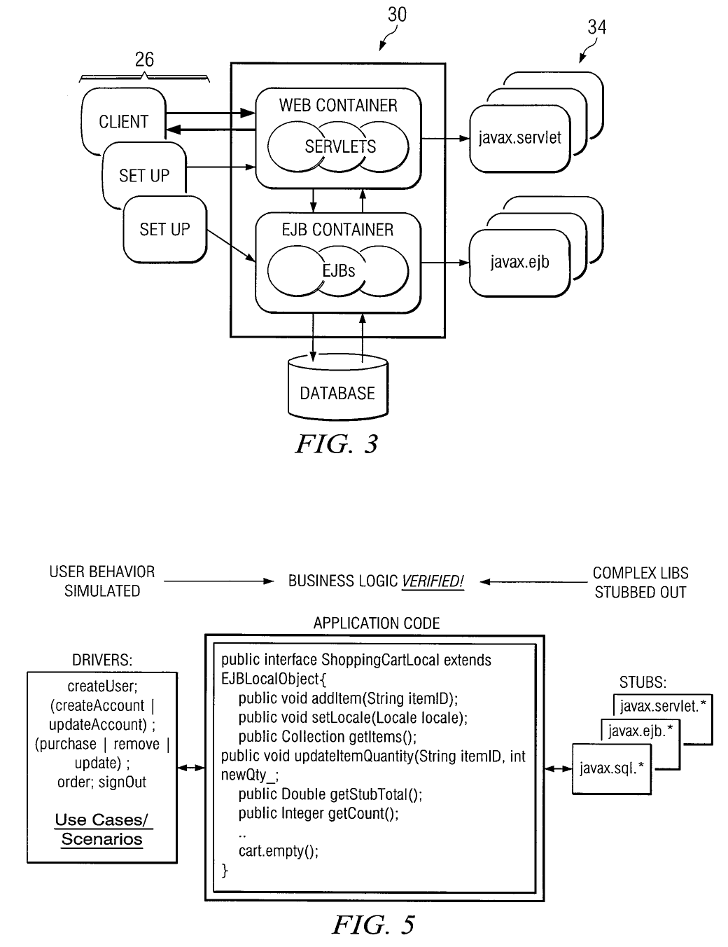

FIG. 3 is a simplified block diagram illustrating an example environment generation for web applications in accordance with one embodiment of the present invention. FIG. 3 includes a set of drivers 26, a module 30 [which includes servlets in a web container, and EJBs in an EJB container], and a set of stubs 34. The stubs include javax.servlet components (stemming from the web container) and javax.ejb components (stemming from the EJB container) in this non-limiting example. Module 30 is coupled to a database, which can include any items necessary for executing the operations of the present invention.

Effectively, an open system is closed with some component (e.g., a human component, or a Java representation of a human component). These systems are non-distributed, where only a single machine is employed. In the final resolution, everything will be pure Java, as whatever components were non-Java would be translated.

Application code, which is code typically written by developers of web applications, can be included within the center component (module 30) of FIG. 3. Drivers 26 will simulate items that happen during deployment time. At deployment time, the set-up code instantiates event-handling classes of both web and EJB layers. In addition, the set-up code fills event-handling mappings according to deployment descriptor files.

In regards to client code, driver generation covers two aspects: user scenarios and user inputs. Scenarios (sequences of events) reuse existing techniques of generating code from automata-based descriptions. They also can use UML-based, XML-based descriptions, and/or WAVE specifications.

To generate user inputs, driver generation supports identification of constant strings (e.g., “userName”) denoting places where a user can input data, e.g., his or her user name. The set of such placeholders is finite: identification is done using static analysis. The placeholders are filled with concrete values (e.g., “J. Smith”), symbolic, or abstract values. Static analysis can be used find domain partitioning and generate all relevant concrete values.

Note that at least one point of novelty in the illustration of FIG. 3 is simply the domain in which the architecture operates. The techniques outlined herein have not been applied to web applications. Also, such techniques have never been applied to open heterogeneous distributed applications.

Turning now to stub generation, specifically with reference to libraries, many classes are modeled as containers (e.g., using Maps to keep keys and their values) using customized static analyses and domain-specific knowledge. EJBs are modeled using their semantics and descriptor files. The database can be modeled as a container that can hold information. Many of the libraries are implemented in a similar fashion. Note that for each domain, the stubs are different, so the semantics of the domain should be examined such that the generated Java code reflects these differences. Stubs can be reused across multiple applications from the same domain.

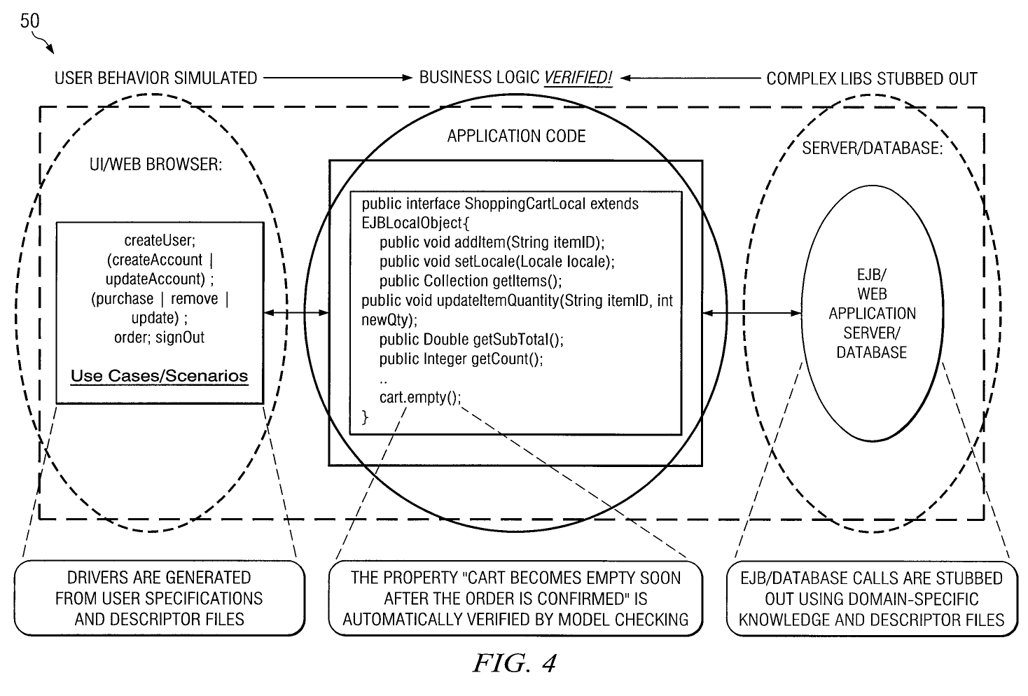

FIGS. 4 and 5 are simplified block diagrams illustrating example architectures for generating a closed homogeneous non-distributed application from open heterogeneous distributed web applications. In FIG. 4, a system 50 is illustrated as one example of an environment generation for web applications. For the driver, use cases can be used to describe a series of actions the user may perform. The module is represented by the center portion of the architecture. Ideally, this module is untouched: meaning that whatever the developer has created will remain intact. On the back end of this system are database and library components.

As is illustrated in FIG. 4, drivers are generated from user specifications and descriptor files. The first section of FIG. 4 illustrates the user behavior being simulated. In the module section, the property “Cart becomes Empty after the Order is Confirmed” is automatically verified by model checking. The business logic is verified in the segment, which includes the application code. J2EE/Database calls are stubbed out using domain-specific knowledge and descriptor files in the third section of the diagram. This includes interaction with a server/database.

A similar example interaction is provided by FIG. 5. Again, there is in interaction between an initial user behavior (relating to the drivers) and the business logic being verified. The application code in the middle of FIG. 5 interacts with the stubs, whereby complex libraries are stubbed out.

A number of case studies have been conducted to further test some aspects of the present invention. For example, SUN's Petstore was tested using the following parameters: 1) domain: J2EE libraries, xml descriptor files; 2) original codebase (excluding libs): 13K NC LOC (Non-Commenting Lines of Code). The environment generated for the Petstore example was 6.5K NC LOC, including the stubs for the library and the driver.

A second case study was performed using a different application, where the application represents a framework for developing web applications. Once the environment is generated, model checking can then be run. The application can be described using the following parameters: 1) domain: J2EE and the framework libraries, xml descriptor files; 2) original codebase (excluding libraries): 63.5K LOC (including comments). The environment generated for this example was 3K NC LOC.

In these scenarios, the architecture provided ideal environment generation techniques for web applications. An open system that is distributed (and not necessarily written in Java, as other languages can readily be used) can transform this data such that the final resultant is a homogenous, non-distributed pure Java program that is ready to be run by existing model-checking techniques (or other techniques such as static analysis). Even without use cases, drivers can be generated to produce useful test cases.

It is critical to note that the components illustrated in FIGS. 3, 4, and 5 may be implemented as digital circuits, analog circuits, software, or any suitable combination of these elements. In addition, any of these illustrated components may include software and/or an algorithm to effectuate their features and/or applications as described herein. The software can execute code such that the functions outlined herein can be performed. Alternatively, such operations and techniques may be achieved by any suitable hardware, component, device, application specific integrated circuit (ASIC), additional software, field programmable gate array (FPGA), processor, erasable programmable ROM (EPROM), electrically erasable programmable ROM (EEPROM), or any other suitable object that is operable to facilitate such operations. Considerable flexibility is provided by the structure of these architectures in the context of this arrangement. Thus, it can be easily appreciated that such functions could be provided external to the outlined environment. In such cases, such a functionality could be readily embodied in a separate component, device, or module.

Although the present invention has been described in detail with specific components being identified, various changes and modifications may be suggested to one skilled in the art and, further, it is intended that the present invention encompass any such changes and modifications as clearly falling within the scope of the appended claims.

Note also that, with respect to specific process flows disclosed, any steps discussed within the flows may be modified, augmented, or omitted without departing from the scope of the invention. Additionally, steps may be performed in any suitable order, or concurrently, without departing from the scope of the invention.

Numerous other changes, substitutions, variations, alterations, and modifications may be ascertained to one skilled in the art and it is intended that the present invention encompass all such changes, substitutions, variations, alterations, and modifications as falling within the scope of the appended claims.

What is claimed is:

1. A method, comprising:
executing processing on an open heterogeneous distributed application, whereby the application is partially written in Java code; and
generating a closed homogeneous non-distributed Java application based on the open heterogeneous distributed application.

2. The method of claim 1, wherein in generating the closed homogeneous non-distributed Java application, drivers and stubs are generated.

3. The method of claim 2, wherein once drivers and stubs are generated, they are combined with an original code base to produce the closed homogeneous non-distributed Java application.

4. The method of claim 2, wherein, in the domain of web applications, driver generation produces a Java implementation of a user component, along with setting up an event-handling mechanism of a web application, which is done at deployment, whereby the stub generation replaces a database and various library components with Java implementations that preserve behaviors.

5. The method of claim 2, wherein the drivers call a module and hold a thread of control.

6. The method of claim 5, wherein the stubs can be called by the module.

7. The method of claim 1, wherein the closed homogeneous non-distributed Java application is purely Java.

8. The method of claim 1, wherein the method for environment generation for web applications is used as a stand-alone tool, which is capable of being used in combination with model-checking, static analysis, or testing.

9. The method of claim 1, wherein application code included in the closed homogeneous non-distributed Java application is included within a module, whereby one or more drivers simulate items that happen during deployment time, and wherein at deployment time, set-up code instantiates event-handling classes of both web and enterprise Java beans (EJB) layers.

10. The method of claim 9, wherein the set-up code fills event-handling mappings according to deployment descriptor files.

11. Logic embedded in a computer medium and operable to:
execute processing on an open heterogeneous distributed application, whereby the application is partially written in Java code; and
generate a closed homogeneous non-distributed Java application based on the open heterogeneous distributed application.

12. The logic of claim 11, wherein in generating the closed homogeneous non-distributed Java application, drivers and stubs are generated.

13. The logic of claim 12, wherein once drivers and stubs are generated, they are combined with an original code base to produce the closed homogeneous non-distributed Java application.

14. The logic of claim 12, wherein driver generation produces a Java implementation of a user component, along with setting up an event-handling mechanism of a web application, which is done at deployment, whereby the stub generation replaces a database and various libraries with Java implementations that preserve behaviors.

15. The logic of claim 12, wherein the drivers call a module and hold a thread of control.

16. The logic of claim 15, wherein the stubs can be called by the module.

17. The logic of claim 11, wherein the closed homogeneous non-distributed Java application is purely Java.

18. The logic of claim 11, wherein the method for environment generation for open heterogeneous distributed applications is used as a stand-alone tool, which is capable of being used in combination with model-checking, static analysis, or testing.

19. The logic of claim 11, wherein application code included in the closed homogeneous non-distributed Java application is included within a module, whereby one or more drivers simulate items that happen during deployment time, and wherein at deployment time, set-up code instantiates event-handling classes of both web and EJB layers.

20. The logic of claim 19, wherein the set-up code fills event-handling mappings according to deployment descriptor files.

21. A system, comprising:
a module that includes application code, wherein processing on an open heterogeneous distributed application is executed, whereby the application is partially written in Java code, and wherein a closed homogeneous non-distributed Java application is generated based on the open heterogeneous distributed application.

22. The system of claim 21, wherein in generating the closed homogeneous non-distributed Java application, drivers and stubs are generated.

23. The system of claim 22, wherein once drivers and stubs are generated, they are combined with an original code base to produce the closed homogeneous non-distributed Java application.

24. The system of claim 22, wherein driver generation produces a Java implementation of a user component, along with setting up an event-handling mechanism of a web application, which is done at deployment, whereby the stub generation replaces a database and various libraries with Java implementations that preserve behaviors.

25. The system of claim 22, wherein the drivers call the module and hold a thread of control, and wherein the stubs can be called by the module.
